(19) United States
(12) Patent Application Publication
(10) Pub. No.: US 2006/0059271 A1
(43) Pub. Date: Mar. 16, 2006

(54) Information processing apparatus, printing apparatus, and printing program

(75) Inventor: Hiroyuki Kato, Mishima-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/931,029

(22) Filed: Sep. 1, 2004

(51) Int. Cl. G06F 15/173

(52) U.S. Cl. 709/238

(57) ABSTRACT

An information processing apparatus, a printing apparatus and a printing program are provided which are capable of not only improving efficiency in print processing but also making efficient the management of print documents on the part of users. The printing program is adapted to make a computer execute a related document information acquisition step that acquires information on documents related to the document to be printed upon receipt of an instruction to print the document to be printed, a related document information attachment step that attaches the related document information acquired in the related document information acquisition step to information on the document to be printed, and a transmission step that transmits to the printing apparatus the information on the document to be printed with the related document information attached thereto in the related document information attachment step.

### BACKGROUND OF THE INVENTION

1. Field of the Invention

The present invention relates to an information processing apparatus that can be connected to a printing apparatus with a storage part so as to make it perform the printing processing of documents to be printed, and the invention also relates to such a printing apparatus and a printing program.

2. Description of the Related Art

In the past, there has been known a technique in which an electronic file including data to be transmitted and a key word concerning the data is prepared in a computer, and then transmitted to another computer where the electronic file thus transmitted is received, and the key word is extracted, so that a directory of concern is detected from a database by making use of the key word thus extracted, and the electronic file is saved or stored into the directory in a hard disk, whereby the data can be saved in an automatically classified state by way of a network without the need for a sender to consider the structure of the hard disk (see, for example, Japanese patent application laid-open No. 2003-223383).

However, in cases where an object to be transmitted is print data, it will be possible to improve efficiency in print processing at a printing apparatus side if the print data with inclusion of various pieces of data information on printing is sent to the printing apparatus side where print processing is done by making use of these pieces of information received. At the same time, at the user side, the management of print documents is made efficient and easy. Accordingly, an information processing apparatus, a printing apparatus and the like with such a function are being demanded.

### SUMMARY OF THE INVENTION

The present invention has been made to solve the problem or demand as referred to above, and is intended to provide an information processing apparatus, a printing apparatus and a printing program which are capable of not only improving efficiency in print processing but also making efficient the management of print documents on the part of users.

In order to achieve the above-mentioned object, according to one aspect of the present invention, there is provided an information processing apparatus adapted to be connected to a printing apparatus so as to make it perform printing processing of a document to be printed, the information processing apparatus comprising: a related document information acquisition part that acquires information on documents related to the document to be printed upon receipt of an instruction to print the document to be printed; a related document information attachment part that attaches the related document information acquired by the related document information acquisition part to information on the document to be printed; and a transmission part that transmits to the printing apparatus the information on the document to be printed with the related document information attached thereto by the related document information attachment part.

According to another aspect of the present invention, there is provided a printing apparatus with a storage part for storing documents, the printing apparatus comprising: a peripheral information acquisition part that acquires peripheral information on a document transmitted when the document is saved; a save destination determination part that determines a save destination of the document based on the peripheral information acquired by the peripheral information acquisition part; and a save execution part that saves the document into the save destination determined by the save destination determination part.

According to a further aspect of the present invention, there is provided a printing program that is adapted to make a computer of an information processing apparatus connectable to a printing apparatus execute: a related document information acquisition step that acquires information on documents related to the document to be printed upon receipt of an instruction to print the document to be printed; a related document information attachment step that attaches the related document information acquired in the related document information acquisition part to information on the document to be printed; and a transmission step that transmits to the printing apparatus the information on the document to be printed with the related document information attached thereto in the related document information attachment step.

According to a still further aspect of the present invention, there is provided a printing program that is adapted to make a computer of a printing apparatus with a storage part for storing documents execute: a peripheral information acquisition step that acquires peripheral information on a document transmitted when the document is saved; a save destination determination step that determines a save destination of the document based on the peripheral information acquired in the peripheral information acquisition step; and a save execution step that saves the document in the save destination determined in the save destination determination step.

### BRIEF DESCRIPTION OF THE DRAWINGS

FIG. 1 is an overall construction view of an information processing apparatus and a print processing apparatus according to the present invention.

FIG. 2 is a block diagram showing the basic construction of the information processing apparatus (client PC) according to one embodiment of the present invention.

FIG. 3 is a block diagram showing the basic construction of an MFP (printing apparatus) according to the embodiment of the present invention.

FIG. 4 is a view showing the construction of a document relation determination section.

FIG. 5 is a view showing the modular construction of a user operation history collection and accumulation part.

FIG. 6 is a view showing the modular construction of an interior of the MFP (printing apparatus).

FIG. 7 is a view showing an internal format of print data.

FIG. 8 is a view showing a designated UI for a related document determination method.

FIG. 9 is a flow chart of the processing performed by a printer driver.

FIG. 10 is a flow chart showing the flow of determining documents related to a document to be printed.

FIG. 11 is a view showing one example of print document information.

FIG. 12 is a view showing one example of a related document list.

FIG. 13 is a flow chart showing the flow of document save destination automatic determination on an MFP (printing apparatus) side.

FIG. 14 is a flow chart showing the flow of save destination determination in the MFP (printing apparatus).

FIG. 15 is a view showing one example of the internal structure of storage management information.

FIG. 16 is a flow chart showing the flow of obtaining printing when there is a print instruction from a user.

FIG. 17 is a view showing one example of an option setting screen by which the user can instruct a printing method when the same document name exists on a printing apparatus.

FIG. 18 is a flow chart showing the flow of formatting and printing a document to be printed and its related documents together.

FIG. 19 is a flow chart showing the flow of printing attribute information on a related document group saved in a document storage in the printing apparatus.

FIG. 20 is a view showing one example of a option setting screen on a printer driver by which the user can give a print instruction for attribute information.

### DESCRIPTION OF THE EMBODIMENT

Hereinafter, a embodiment of the present invention will be described in detail while referring to the accompanying drawings.

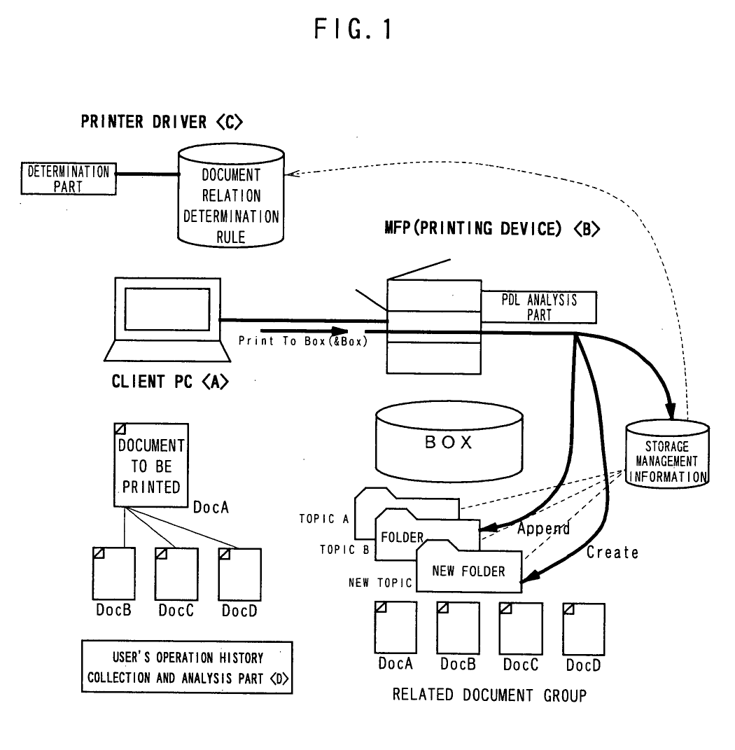

FIG. 1 is an overall construction view that shows the state of an information processing apparatus and a printing apparatus being connected to each other according to this embodiment. In FIG. 1, the information processing apparatus is comprised of a client PC (personal computer) <A>, and the printing apparatus is comprised of an MFP (printing apparatus) <B>. These apparatuses are connected to each other through a network, but one or more of information processing apparatuses and one or more of printing apparatuses can be provided and connected to one another.

A printer driver <C>, a user's operation history collection and analysis part <D> and various applications (for example, Microsoft Office Suite, mailer, Internet Explorer, Lotus Notes (registered trademark), etc.) are installed in the client PC <A>.

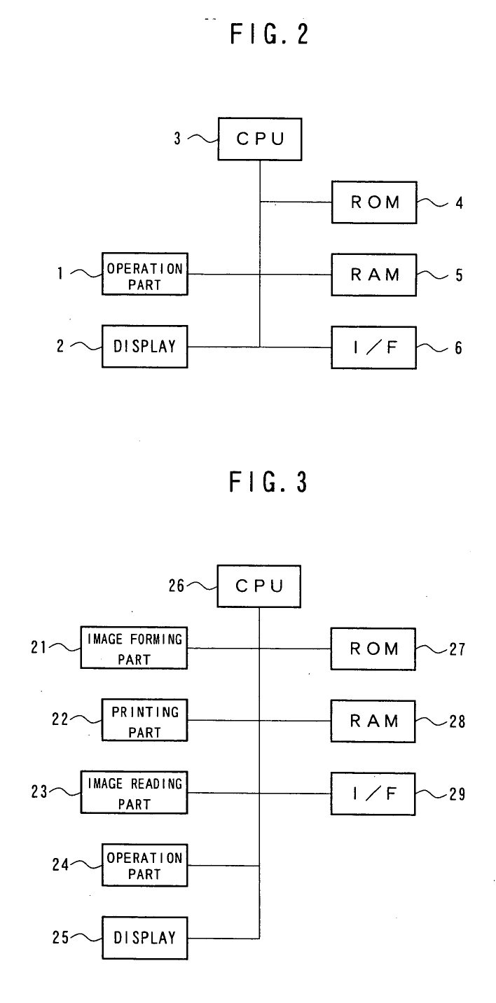

FIG. 2 is a circuit block diagram that shows the basic construction of the information processing apparatus (client PC <A>) shown in FIG. 1. The document information processing apparatus (client PC <A>) comprises an operation part 1 that performs document operation, a display 2 that displays documents or operations, a CPU (Central Processing Unit) 3 that takes charge of control operation, a ROM (Read Only Memory) 4 that serves as a memory part, a RAM (Random Access Memory) 5, and an interface 6.

FIG. 3 is a circuit block diagram that shows the basic construction of the MFP (printing apparatus) <B> as shown in FIG. 1. The MFP (printing apparatus) <B> includes an image forming part 21, a printing part 22, an image reading part 23, an operation part 24, a display 25, a CPU (Central Processing Unit) 26, a ROM Read Only Memory) 27, a RAM (Random Access Memory) 28, and an interface 29.

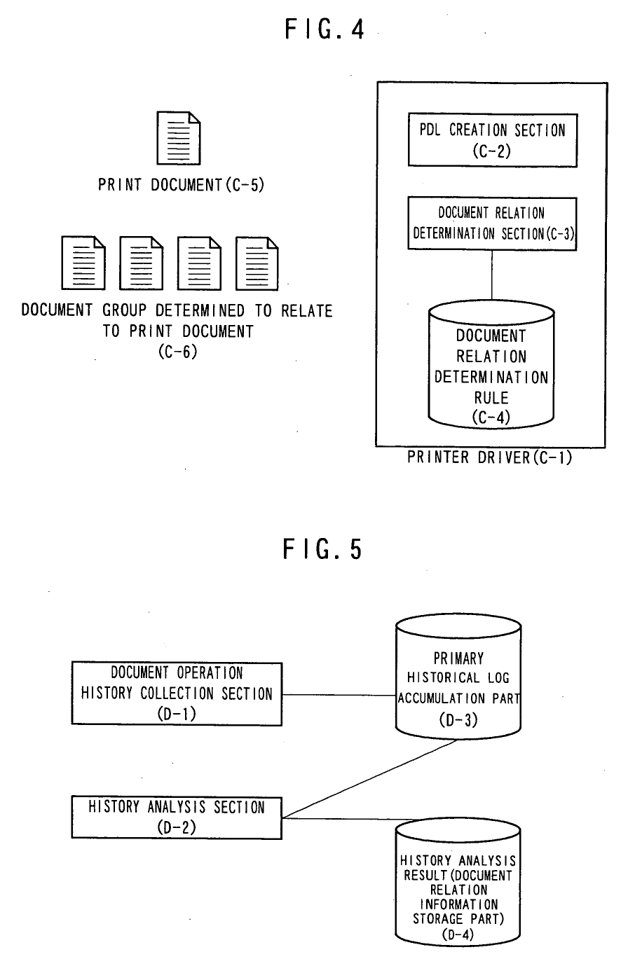

FIG. 4 is a view that shows the construction of a document relation determination section. The document relation determination section is a module that is installed on a client PC <A>, and exists, for example, on a printer driver (C-1). The printer driver (C-1) includes therein a PDL creation section (C-2), and a document relation determination section (C-3). The document relation determination section (C-3) makes a document relation determination by using a document relation determination rule (C-4), and constitutes a related document determination part of the present invention that is used for the acquisition of related document information.

FIG. 5 is a view that shows the modular construction of a user's operation history collection and accumulation part that is included in the document relation determination section (C-3) shown in FIG. 4.

The operation history collection and accumulation part shown in FIG. 5 includes a related information accumulation part (D-4) that accumulates document relation information as the operation history collection section (D-1) to the document and the history analysis section (D-2), the primary historical log accumulation part (D-3), and the history analysis result.

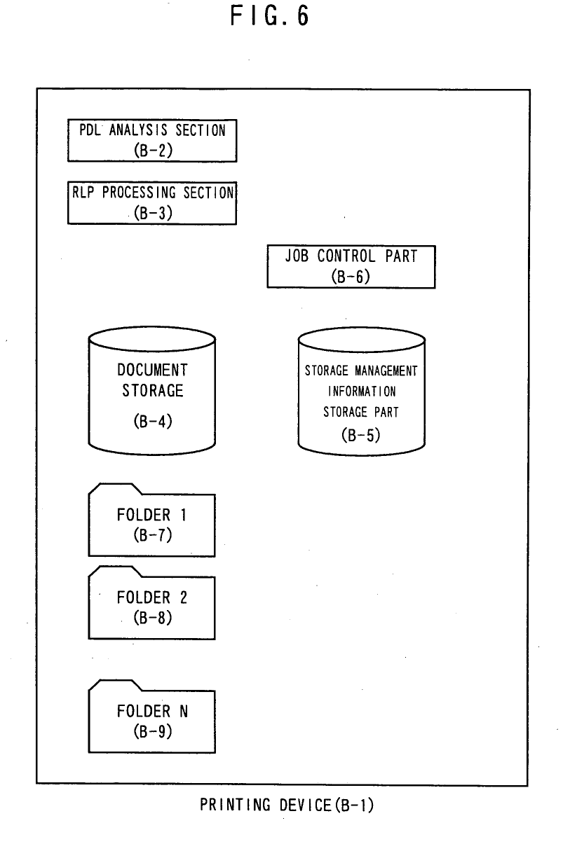

FIG. 6 is a view that shows the modular construction of the interior of the MFP (printing apparatus) <B>. The MFP (printing apparatus) <B> includes a PDL analysis section (B-2), a RIP processing section (B-3), a job control part (B-6), a document storage (B-4) that stores documents themselves, and a storage management information storage part (B-5) that stores storage management information in the document storage. Here, note that in the document storage (B-4), there exist save folders such as folder 1 (B-7), folder 2 (B-8), folder N (B-9), etc., as illustrated.

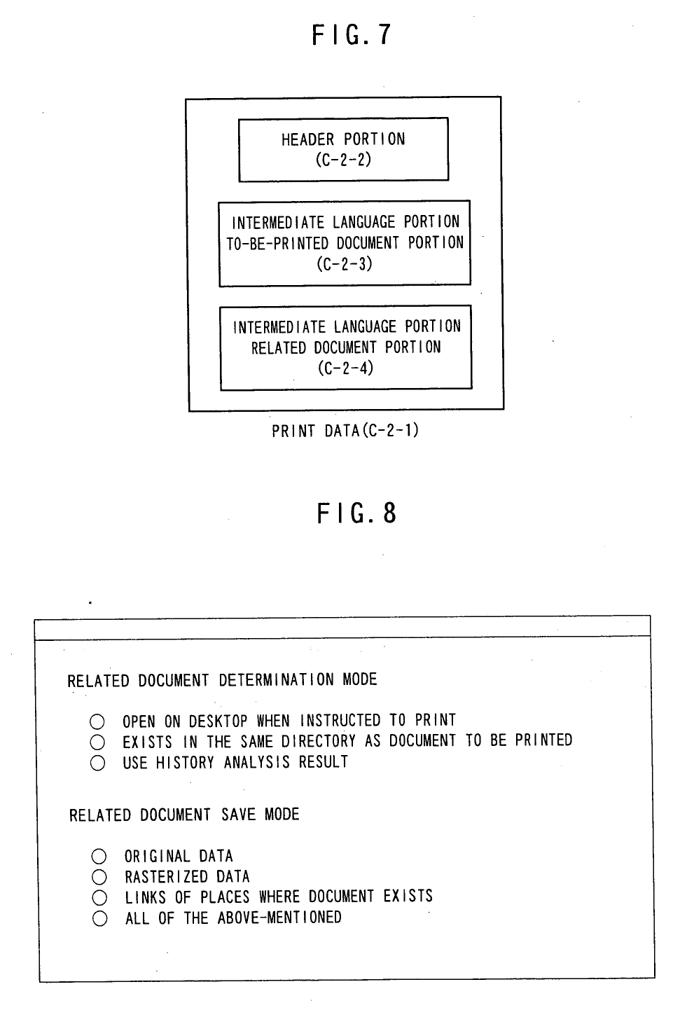

FIG. 7 is a view that shows an internal format of print data. Print data (C-2-1) comprises three portions, i.e., a header portion (C-2-2), a to-be-printed document portion (C-2-3) of an intermediate language portion (PDL [Printer Description Language] used in a printer), and a related document portion (C-2-4) of the intermediate language portion. To-be-printed document information, being information on the document to be printed, and the related document information, being information on documents to be printed, are described in the header portion (C-2-2).

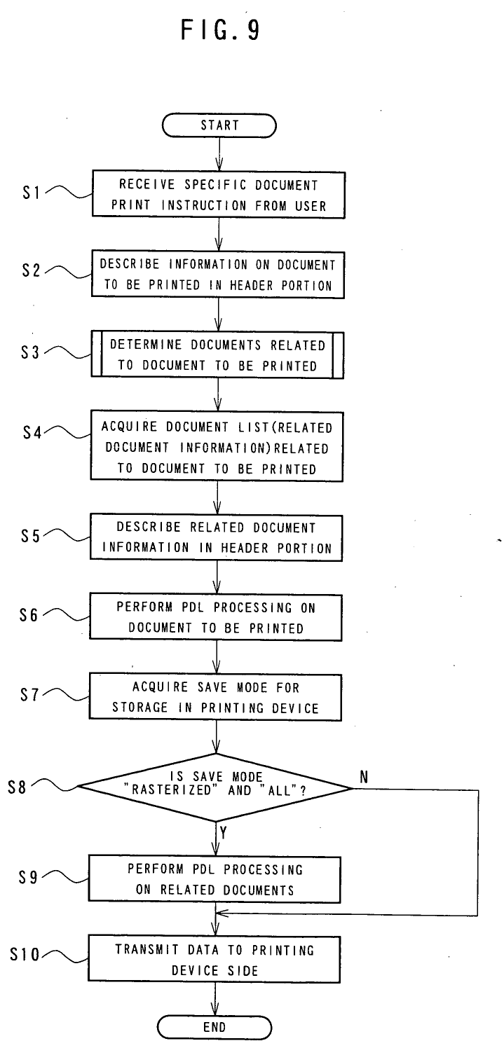

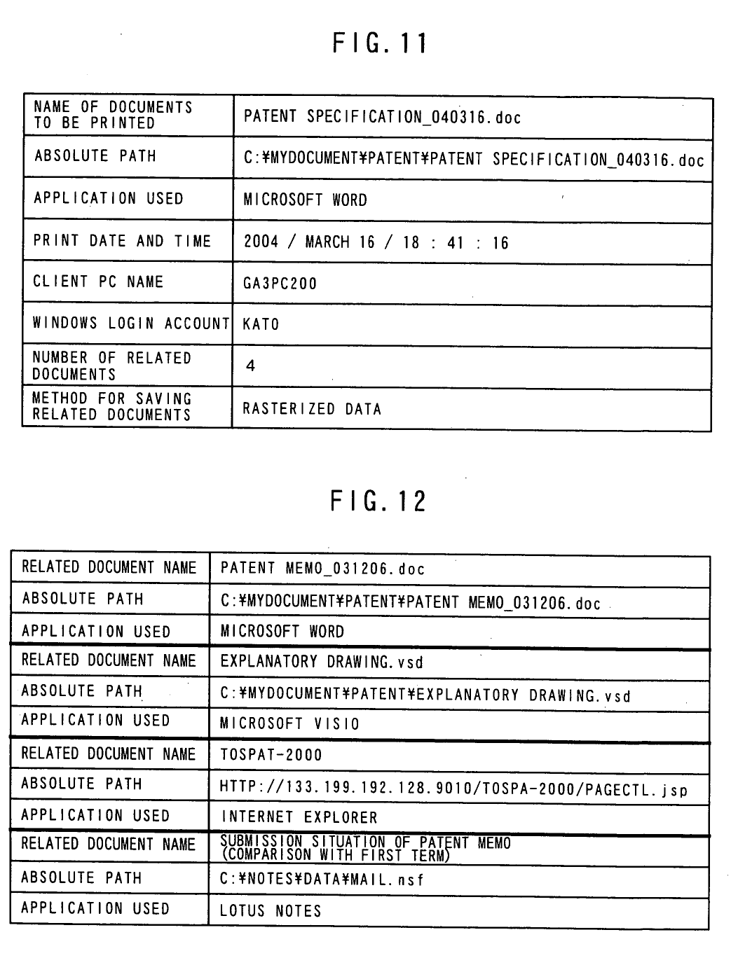

Next, reference will be made to the processing performed by the information processing apparatus (i.e., the printer driver (C-1)) by using a flow chart of FIG. 9. When an instruction to print a specific document is received from a user (step S1), information on the document to be printed is described in the header portion C-2-2) (step S2). The content to be described is equal to print document information that is illustrated in FIG. 11. Then, the document relation determination section (C-3) determines documents related to the document to be printed (step S3), and a document list is acquired which is the related document information related to the document to be printed (step S4). The document list is illustrated in FIG. 12. According to the document list of FIG. 12, it includes the names of related documents, absolute paths representing their locations, and applications used for creation of the documents.

Subsequently, this document list is described in the header portion (C-2-2) as the related document information (step S5). PDL processing is performed on the document to be printed (step S6), and a save mode to the storage in the printing apparatus is acquired (step S7).

The step S7 constitutes a “save mode acquisition part” to acquire the save mode of the related documents. Here, note that this save mode is set by permitting the user to select an appropriate one from among a plurality of existing save modes including an “original data” mode, a “rasterized data” made, and an “all of the above” mode, as illustrated in FIG. 8.

Then, it is determined whether the save mode thus acquired is the “rasterized data” or “all the above” mode or not (step S8), and when a positive determination is made (step S8, Y), the PDL processing of the related documents is performed (step S9), whereas when a negative determination is made (step S8, N), the PDL processing of the related documents is not performed, but the print data thus created is transmitted to the printing apparatus side (step S10). The step S4 in this flow constitutes a “related document information acquisition part” and a “related document information acquisition step” in the present invention, and the step S5 constitutes a “related document information attachment part” and a “related document information attachment step”, and the step S10 constitutes a “transmission part” and a “transmission step”.

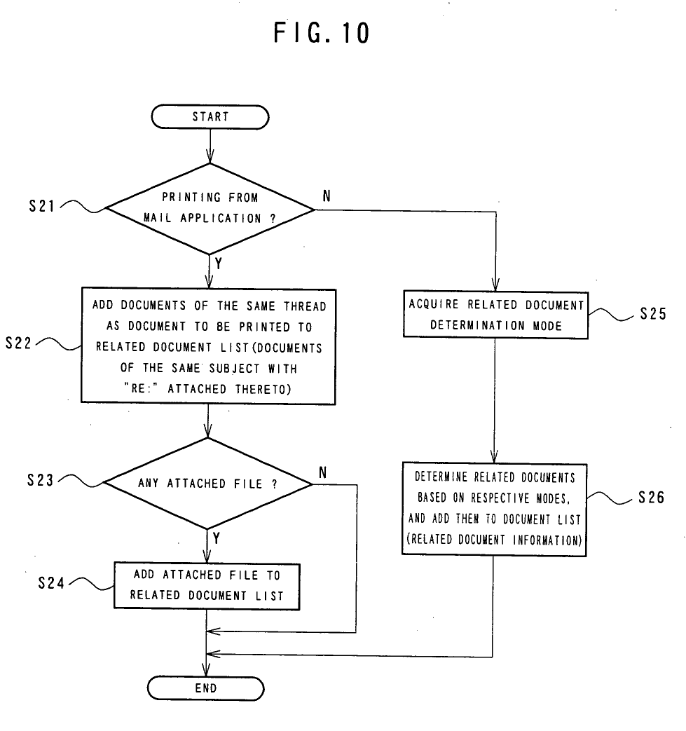

Next, reference will be made to the details of a processing part that makes a determination as to whether “a document is related to the document to be printed” in FIG. 9 (step S3), by using a flow chart of FIG. 10 as one example of the processing in a mail application. First of all, it is determined whether it is a print document from a mail application (step S21), and when it is a print document from a mail application (step S21, Y), the document of the same thread (documents which have the same subject with “Re:” attached thereto) as the document to be printed is added to the related document list (step S22). Then, it is determined whether there is an attached file (step S23), and when an attached file exists (step S23, Y), the attached file is added to the related document list (step S24).

On the other hand, when it is not a print document (step S21, N) from a mail application, a related document determination mode is acquired (step S25). The related document determination mode includes three modes as illustrated in FIG. 8. Here, the following three modes are provided: a first one in which documents “being open on the desk top when a print instruction is given” are determined to be related documents; a second one in which documents “existing in the same directory as the document to be printed” are determined to be related documents; and a third one in which related documents are determined “by making use of a history analysis result”.

Thus, the above-mentioned modes become determination rules, respectively, and the related documents thus determined based on the determination rules are added to the related document list (step S26). The steps S21 through S23, S25 and S26 in this flow constitute a “related document determination part” and a “related document determination step” in the present invention, and the step S25 also constitutes a “determination mode acquisition part” and a “determination mode acquisition step” in the present invention. Moreover, related documents are also determined in accordance with the kind of the document to be printed, as determined in step S21.

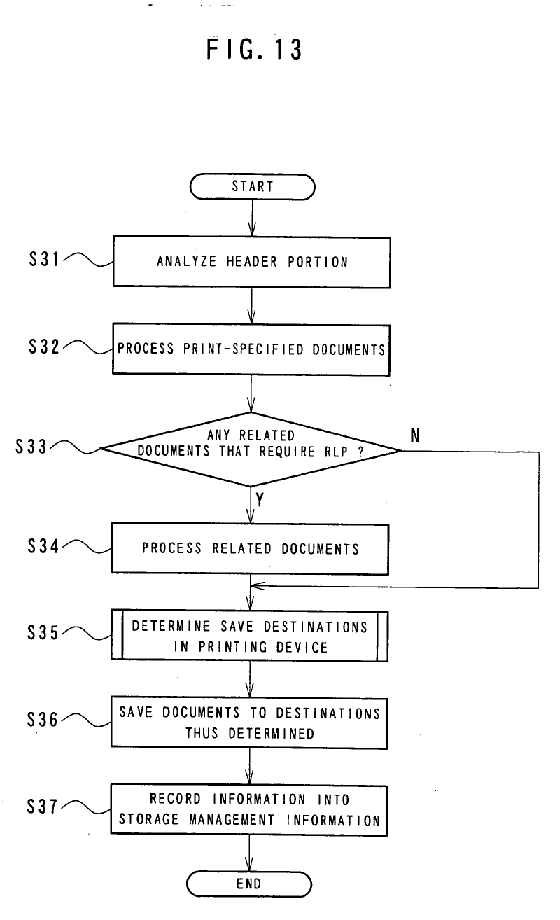

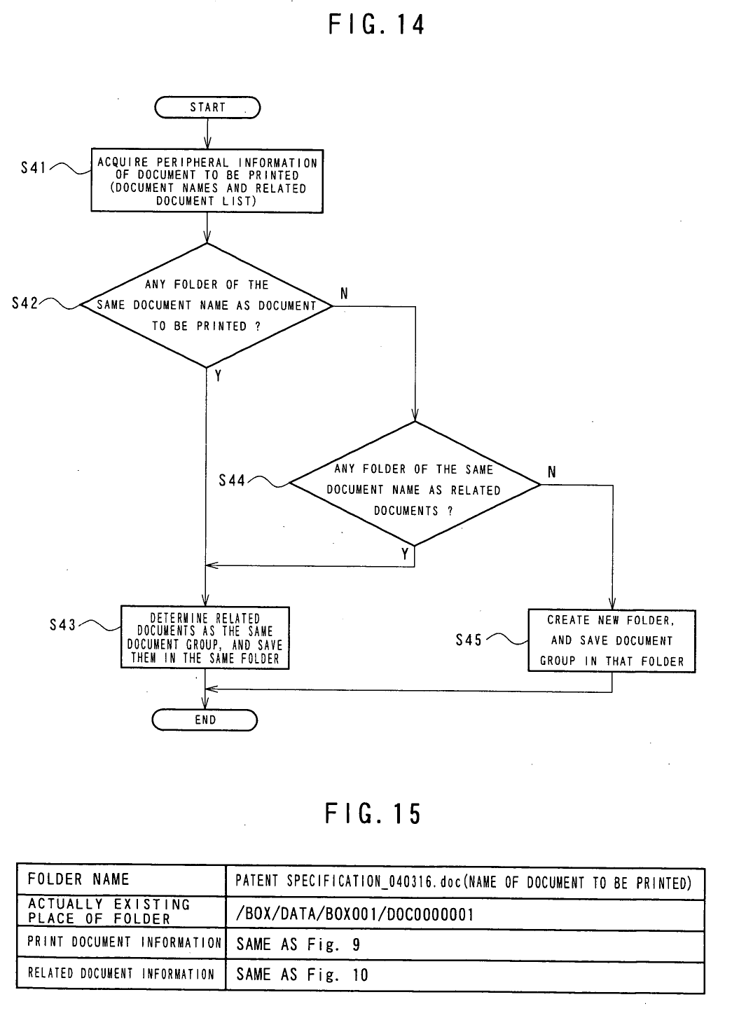

Now, reference will be made to the flow of the automatic determination of the document save destination on the MFP (printing apparatus) <B> side by using a flow chart of FIG. 13. First, when print data is sent from the client PC <A>, the header portion (C-2-2) in the print data is analyzed (step S31), so that print document information (FIG. 11) and related document information (FIG. 12: document list) are taken out. Then, the RIP processing of a print-designated document is performed to rasterize the print document (step S32). Based on the print document information already acquired and the save mode, it is determined whether the RIP of the related document group is necessary (step S33). When the RIP processing is necessary (step S33, Y), the RIP processing is performed (step S34). Thereafter, a determination is made as to which folders (B-7) through (B-9) in the document storage (B-4) of the printing apparatus the document to be printed and the related document group are saved step S35). Details of this determination processing will be described later by using FIG. 14. Subsequently, when the save destination is determined, the processing of saving the documents to the destination thus determined is carried out (step S36), and this saving information is recorded into the storage management information (step S37). The step S35 in this flow constitutes a “save destination determination part” of the present invention, and the step S36 constitutes a “save execution part” of the present invention.

Next, reference will be made in detail to the save destination determination processing in the printing apparatus (step S35) in FIG. 13 by using FIG. 14. First of all, the peripheral information of the document to be printed is acquired from the print document list (FIG. 11) and the document list (FIG. 12) (step S41). The peripheral information is information such as, for example, document names,information contained in the related document list, etc. Here, note that the step S41 constitutes a “peripheral information acquisition part” and a “peripheral information acquisition step” of the present invention. Then, based on the information acquired from the storage management information storage part (B-5), it is determined whether there exists any folder that contains the same document name as that of the document to be printed (step S42). The storage management information storage part (B-5) contains a folder name, the actually existing place of a folder, the print document information, and the related document information, as illustrated in FIG. 15. When there exist documents to be printed of the same document name(step S42, Y), a group of documents of the same document name are saved in the same folder (step S43). When there is no document of the same document name (step S42, N), it is determined whether there exists any folder of the same name as the document name of any of the related documents (step S44), and if there exists a folder of the same name, the document group are saved into the same folder (step S43). If not in either of the above cases (step S44, N), however, a new folder is created so that the document group are saved in the new folder (step S45). When the document group are written or saved into the same folder, either of the following methods can be taken.

(1) Version management is performed, and the documents of respective versions are held in the storage.

(2) The documents are appended.

(3) The documents are overwritten.

In this flow, the steps S42, S44 together constitute a “save destination determination part” and a “save destination determination step” of the present invention, and the steps S43, S44 together constitute a “save execution part” and a “save execution step” of the present invention.

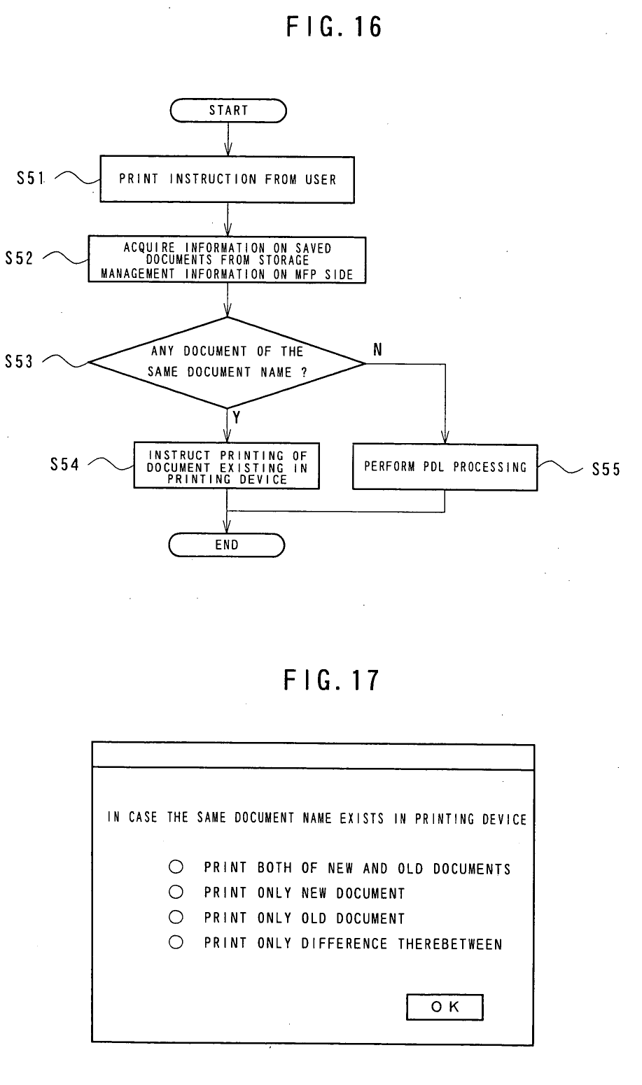

In FIG. 16, the processing from the issuance of user's print instruction to printing will be described. When a document print instruction is generated from the client PC <A> by a user (step S51), the printer driver (C-1) makes reference to the storage management information storage part (B-5) in the MFP (printing apparatus) <B> by way of the network, and acquires information on the documents saved therein (step S52). Here, it is determining whether there exist documents of the same document name as that of the document to be printed exists (step S53). When such documents exist (step S53, Y), an instruction for printing the documents existing in the MFP (printing apparatus) <B> is sent from the printer driver C-1) to the MFP (printing apparatus) <B>. In that case, the printer driver (C-1) can perform printing by the use of already rasterized data without requiring the processing of creating PDL data, so a processing time for PDL creation and a RIP processing time can be omitted, thus making it possible to shorten the time from the print instruction to printing. On the other hand, when there exists no document of the same document name as that of the document to be printed (step S53, N), the processing of creating PDL data is carried out. Here, note that the step S53 in this flow constitutes a “save document determination part” and a “save document determination step” in the present invention.

As a modified example of the above method, the document to be printed has a unique ID (identifier) in its interior, and a determination as to whether a certain document is the same document as the one to be printed is made by verifying in the printing apparatus whether the ID of the certain document is identical to the ID of the document to be printed. In addition, in case where the user performs proofreading, the documents of the same document name may often change little by little in their contents from one another, and when it is determined by the names of the documents whether the documents are identical with one another, there will be the following three cases.

(1) When the documents are determined as the same document and rasterized data in the printing apparatus is printed, the result of the printing might become different from the one desired by the user.

(2) The user wants to print both the rasterized data of old versions stored in the printing apparatus and new print data for which a print instruction is currently given.

(3) The user wants to print only different parts between the new and old documents.

Accordingly, a user interface (UI) that can enable the user to make a selection between (1) though (3) above is provided, and the UI is switched over between these functions (FIG. 17).

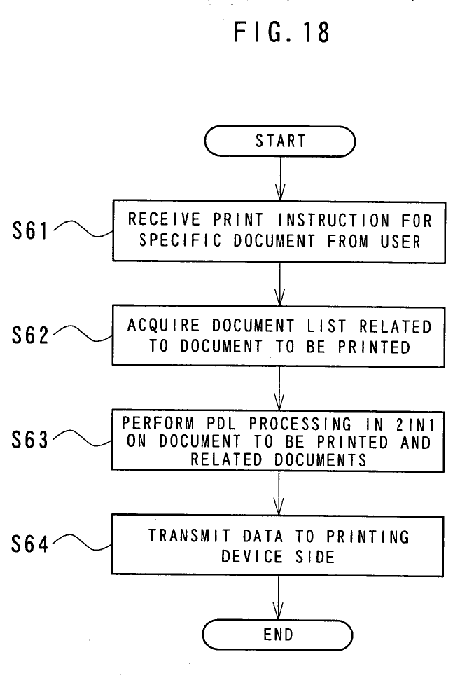

Now, reference will be made to the flow of the processing of automatically printing a document to be printed and the related document group other than the document to be printed in a collective manner by using FIG. 18. First, upon receipt of an instruction for printing a specific document from the user (step S61), a document list related to the document to be printed is acquired according to the processing flow as illustrated in FIGS. 9, 10 (step S62). Then, the document to be printed and the related documents are subjected to PDL processing, but in this case, the PDL processing is performed at a finishing mode designated by the user (step S63). The print data is sent to the printing apparatus side (step S64). Here, note that in this flow, the step S62 constitutes a “related document acquisition part” and a “related document acquisition step” in the present invention, and the step S63 constitutes a “formatting part” and a “formatting step” in the present invention.

Thus, the document to be printed and the related documents are formatted and printed together, so the user can obtain printing only by providing one print instruction without the need of opening individual corresponding applications separately to give respective print instructions.

For example, in the case of printing email documents, it is possible to print all the threads of an email or print the body of an email message and its attached files, with a single instruction. Also, by doing finishing such as stapling, hole punching, tab printing, etc., the related documents as printed can be collectively handled as paper.

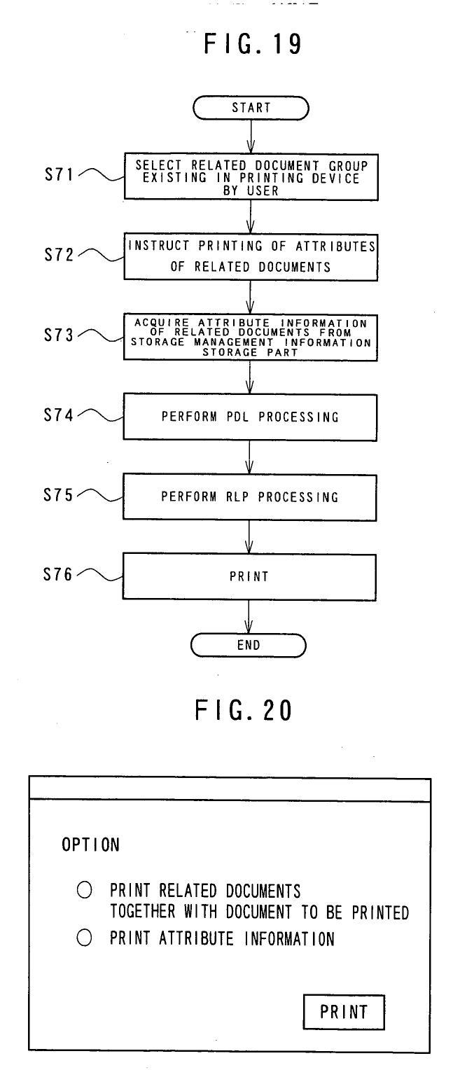

Next, reference will be made to the printing of attribute information of the related document group by using FIG. 19. The related document group existing in the MFP (printing apparatus) <B> is selected by the user (step S71). This is equivalent to the selection of a certain related document group. Then, for example, on an option setting screen of the printer driver (C-1), as shown in FIG. 20, the user instructs that the attributes of the related documents should be printed (step S72). The system acquires the attribute information of the related documents from the storage management information storage part (B-5) (step S73), performs PDL processing (step S74), and performs RIP processing (step S75), after which it executes printing (step S76). Here, note that in this flow, the step S73 constitutes an “attribute information acquisition part” and an “attribute information acquisition step” in the present invention.

By printing the attribute information of the related document group in this manner, the user can make practical use of the attribute information on the related documents.

Although one embodiment of the present invention has been described above, the present invention is not limited to this embodiment as far as not departing from the gist thereof.

In addition, although in this embodiment, the processing operations illustrated in FIG. 9, FIG. 10, FIG. 13 and FIG. 14 are executed by a computer based on the programs stored in the apparatus (information processing apparatus, MFP), these programs are not limited to the case where they are stored in the apparatus. That is, similar functions can be downloaded into the apparatus via a network, or a computer-readable recording medium storing therein similar functions can be installed in the apparatus. Such a recording medium can be of any form such as a CD-ROM, which is able to store programs and which is able to be read out by the apparatus. In addition, the functions to be obtained by such preinstallation or downloading can be achieved through cooperation with an OS (operating system) or the like in the interior of the apparatus.

What is claimed is:

1. An information processing apparatus adapted to be connected to a printing apparatus so as to make it perform printing processing of a document to be printed, said apparatus comprising:
a related document information acquisition part that acquires information on documents related to said document to be printed upon receipt of an instruction to print said document to be printed;
a related document information attachment part that attaches the related document information acquired by said related document information acquisition part to information on said document to be printed; and
a transmission part that transmits to said printing apparatus the information on said document to be printed with the related document information attached thereto by said related document information attachment part.

2. The information processing apparatus as set forth in claim 1, wherein said related document information includes information indicating the location of related documents.

3. The information processing apparatus as set forth in claim 1, further comprising a save mode acquisition part that acquires a save mode when said related documents are saved in said printing apparatus.

4. The information processing apparatus as set forth in claim 3, wherein said save mode acquisition part acquires said save mode by making a selection from among a plurality of existing modes.

5. The information processing apparatus as set forth in claim 1, wherein said related document information acquisition part includes a related document determination part that makes a determination of said related documents in accordance with the kind of said document to be printed.

6. The information processing apparatus as set forth in claim 1, further comprising a determination mode acquisition part that can acquire, through selection from among a plurality of existing modes, a determination mode to determine and acquire said related documents, which is used when said related documents are acquired by said related document information acquisition part.

7. A printing apparatus with a storage part for storing documents, said apparatus comprising:
a peripheral information acquisition part that acquires peripheral information on a document transmitted when said document is saved;
a save destination determination part that determines a save destination of said document based on said peripheral information acquired by said peripheral information acquisition part; and
a save execution part that saves said document into said save destination determined by said save destination determination part.

8. The printing apparatus as set forth in claim 7, wherein
said save destination determination part determines, upon saving of said document, whether said document has relation to an existing document group saved in said storage part in said printing apparatus; and
said save execution part saves said document into a save destination related to said existing document group when said document has relation to said existing document group.

9. The printing apparatus as set forth in claim 6, further comprising: a save document determination part that, upon issuance of a print instruction, makes a determination, based on information on a document related to said print instruction, as to whether documents of the same document name as that of said document have already been saved in said storage part, wherein when said save document determination part determines that documents of the same document name as that of the document related to said print instruction have already been saved, printing is carried out by using saved data of said saved documents.

10. The printing apparatus as set forth in claim 6, further comprising:.
a related document acquisition part that acquires documents related to said document to be printed for which a print instruction is given; and
a formatting part that formats said related documents acquired by said related document acquisition part, together with said document to be printed;
wherein said documents formatted by said formatting part are collectively printed by said printing apparatus.

11. The printing apparatus as set forth in claim 6, further comprising:
an attribute information acquisition part that acquires attribute information of said related documents from management information in the storage part upon receipt of an instruction to select a related document group saved in said storage part, and upon receipt of an instruction to print attributes of said related documents,
wherein said attribute information acquired by said attribute information acquisition part is printed by said printing apparatus.

12. A printing program adapted to make a computer of an information processing apparatus connectable to a printing apparatus execute:
a related document information acquisition step that acquires information on documents related to said document to be printed upon receipt of an instruction to print said document to be printed;
a related document information attachment step that attaches the related document information acquired in said related document information acquisition part to information on said document to be printed; and
a transmission step that transmits to said printing apparatus the information on said document to be printed with the related document information attached thereto in said related document information attachment step.

13. The printing program as set forth in claim 12, wherein said related document information acquisition step includes a related document determination step that makes a determination of said related documents in accordance with the kind of said document to be printed.

14. The printing program as set forth in claim 12, wherein said program is adapted to make said computer further execute a determination mode acquisition step that can acquire, through selection from among a plurality of existing modes, a determination mode used in said related document information acquisition step to determine and acquire said related documents.

15. A printing program adapted to make a computer of a printing apparatus with a storage part for storing documents execute:
a peripheral information acquisition step that acquires peripheral information on a document transmitted when said document is saved;
a save destination determination step that determines a save destination of said document based on said peripheral information acquired in said peripheral information acquisition step; and
a save execution step that saves said document in said save destination determined in said save destination determination step.

16. The printing program as set forth in claim 15, wherein in said save destination determination step, it is determined, upon saving of said document, whether said document has relation to an existing document group saved in any portion of said storage part in said printing apparatus, and when it is determined that said document has relation to an existing document group saved in a portion of said storage part in said printing apparatus, said computer is made to execute determining that the portion of said storage part in which said existing document group is saved is a save destination into which said document is to be saved.

17. The printing program as set forth in claim 15, wherein said program is adapted to make said computer further execute a save document determination step that, upon issuance of a print instruction, makes a determination, based on information on a document related to said print instruction, as to whether documents of the same document name as that of said document have already been saved in said storage part, and when it is determined in said save document determination step that documents of the same document name as that of the document related to said print instruction have already been saved, said computer is made to execute printing by using the saved data of said saved documents.

18. The printing program as set forth in claim 15, wherein said program is adapted to make said computer further execute:
a related document acquisition step that acquires documents related to said document to be printed for which a print instruction is given; and
a formatting step that formats said related documents acquired in said related document acquisition step, together with said document to be printed;
wherein said computer is made to collectively print said documents formatted in said formatting step.

19. The printing program as set forth in claim 15, wherein said program is adapted to make said computer further execute an attribute information acquisition step that acquires attribute information of said related documents from management information in said storage part upon receipt of an instruction to select a related document group saved in said storage part, and upon receipt of an instruction to print attributes of said related documents;
wherein said computer is made to print said attribute information acquired in said attribute information acquisition step.
